(19) United States
(12) Patent Application Publication
(10) Pub. No.: US 2012/0216269 A1
(43) Pub. Date: Aug. 23, 2012

(54) Software licensing in a virtualization environment

(75) Inventors: Michael Yeung, Nepean (CA); Jean-yves Patry, Gatineau (CA); Tom Gray, Mansfield (CA)

(73) Assignee: Mitel Networks Corporation

(21) Appl. No.: 13/373,463

(22) Filed: Nov. 14, 2011

Related U.S. Application Data
(60) Provisional application No. 61/463,578, filed on Feb. 18, 2011.

(51) Int. Cl. G06F 21/22; G06F 9/445; G06F 17/00

(52) U.S. Cl. 726/11; 726/26

(57) ABSTRACT

Provided are a system and method for activating an unauthorized software program in a virtualization environment. A software program is installed on a computer. A valid license is obtained to activate the software program. A cloning operation is performed on the software program. At least one other instance of the software program is generated during the cloning operation. The valid license is obtained to activate the at least one other instance of the software program. Also provided are systems and methods for identifying and counteracting unauthorized licensing of instances of a software program.

### RELATED APPLICATIONS

This application claims the benefit of the earlier filing date of U.S. provisional patent application Ser. No. 61/463,578, filed Feb. 18, 2011 and entitled “Anti-Fraud Mechanisms for Licensing of Virtualized Systems,” the content of which is incorporated herein by reference in its entirety.

### FIELD OF THE INVENTION

The present application relates generally to software licensing in a virtualization environment, and more particularly, to techniques related to unauthorized licensing of instances of a software program in a virtualized system, and systems and methods for identifying and counteracting such techniques.

### BACKGROUND

As software-related technologies evolve, the complexity of corresponding software programs continues to increase, along with the value of the programs. Software programs of value are particularly prone to illegal reproduction.

When a software program is installed on a computer, the program can be configured to require a unique key, token, and the like in order to “activate” the program. This feature is useful in confirming that the installed software program is original, and in preventing the software program from being used by multiple parties. Accordingly, a software program, even when copied, can be used without a license.

Software vendors often associate each license key, token, and the like with the MAC address of the computer at which the software program is installed in order to deter users from unauthorized copying of the software program on other computers. In this manner, if a user wishes to run an installed software program on a different computer, a new license is required.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a diagram illustrating a software licensing environment;

FIG. 2 is a diagram illustrating a network environment in which a licensing server is in communication with a virtualized computer, in accordance with an embodiment;

FIG. 3 is a flow diagram of a method for cloning instances of a licensed software program in a virtualization system, in accordance with an embodiment;

FIG. 4 is a flow diagram of a method for detecting software program cloning fraud, in accordance with an embodiment;

FIG. 5 is a flow diagram of another method for detecting software program cloning fraud, in accordance with an embodiment;

FIG. 6 is a diagram illustrating another network environment in which a licensing server is in communication with a virtualized computer, in accordance with an embodiment;

FIG. 7 is a flow diagram of a method for configuring a firewall to prevent the detection of cloning fraud, in accordance with an embodiment;

FIG. 8 is a flow diagram of another method for detecting software program cloning fraud, in accordance with an embodiment;

FIG. 9 is a flow diagram of another method for configuring a firewall to prevent the detection of cloning fraud, in accordance with an embodiment.

FIG. 10 is a flow diagram of a method for detecting a license request from a software program clone, in accordance with an embodiment;

FIG. 11 is a flow diagram of a method for performing repetitive cloning, in accordance with an embodiment;

### DETAILED DESCRIPTION OF EXAMPLE EMBODIMENTS

The description set forth below in connection with the appended drawings is intended as a description of embodiments of the present inventive concepts. It is to be understood that the present inventive concepts are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

The emergence of software as a service (SaaS), virtualization, cloud computing, and related technologies allows for greater scaling, and allows for resiliency in the face of network or server failure and for purposes of efficiency in load balancing. However, a virtualized hardware platform can include multiple instances of a same software program. Thus, conventional licensing models that associate a license with a MAC address or other hardware-related identifier can be ineffective, since virtualization technology software runs on virtual machines which in turn run on physical servers situated anywhere within the cloud. However, these virtual machines are created at will and have no unique physical identifiers, for example, no MAC address for each virtual machine, to which a software license can otherwise be associated.

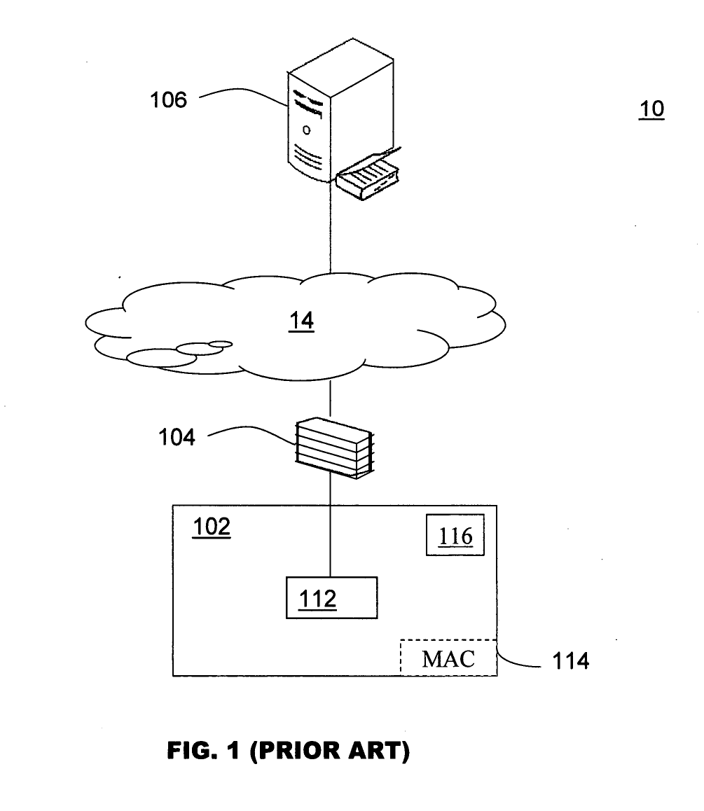

FIG. 1 is a network diagram illustrating a software licensing environment 10. The environment 10 includes a computer 102, which can be located at a customer premises, a data center, or other location. The computer 102 can be any electronic device having a software program 112 stored in memory and a central processing unit (CPU) 116 configured to carry out the instructions of the software program 112, for example, a private branch exchange (PBX). The software program 112 can be part of an application or other program comprising code. The computer 102 communicates with a licensing server 106 via a network 14, for example, a local area network (LAN) and/or a wide area network (WAN). The licensing server 106 can be located at a vendor premises, a data center, or related location. A firewall 104 can be positioned between the computer 102 and the network 14.

The licensing server 106 is configured to provide a license, which can be in the form of a token, key, file, and the like, to the computer 102 to activate the software program 112 for use. The licensing server 106 can validate the license at predetermined or random intervals, and take remedial action in the event that an invalid license is detected.

The licensing server 106 can rely on a relationship between a physical attribute of the computer 102 and the software program 112 running on the computer 102. For example, the computer 102 can have a unique IEEE 802 MAC address 114. A license for the software program 112 can be bound to the MAC address 114. As part of a software program verification process, the licensing server 106 can encrypt the MAC address and return it as a token to the computer 102. The token cannot be easily duplicated since it depends on a unique hardware aspect, i.e., the MAC address of the computer 102. The software program 112 can decrypt the received token, for example, by the user entering a product key or other access code. Here, the MAC address provided with the token can be verified as being the MAC address of the computer 102.

Licensing-related limitations arise when the computer 102 is configured with virtualization technology software running on virtual machines created on the computer 102, in particular, when software vendors require that each instance of a software program installed on a virtual machine has a license.

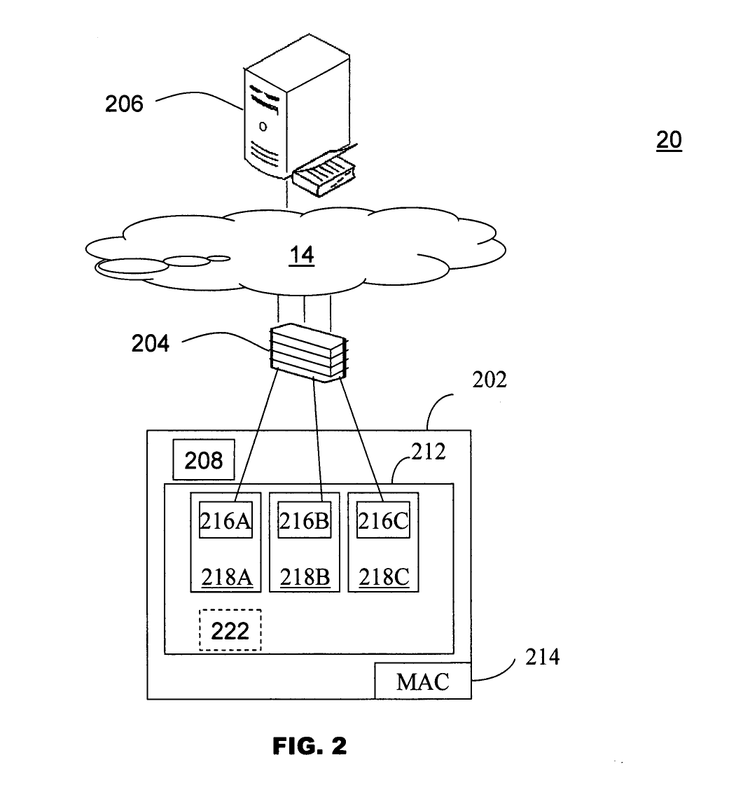

FIG. 2 is a network diagram illustrating a network environment 20 in which a licensing system 206 is in communication with a virtualized computer 202, in accordance with an embodiment.

A feature of virtualization technology is that an application software program can be cloned. For example, the computer 202 can be configured to host a plurality of applications 216A, 216B, 216C (generally, 216) configured on virtual machines 218A, 218B, 218C (generally, 218), respectively, at a storage device 212, e.g., memory. Applications 216B and 216C can be instances of the same application or other software program, i.e., application 216A. For example, applications 216B, C can be copies, or cloned instances, of application 216A, each copy executed at a different virtual machine 218 of the computer server 202. Alternatively, applications 216 can be installed on multiple servers situated anywhere in the cloud. Thus, applications 216 can be moved among virtual machines on different physical servers.

Virtualization technology can create problems for licensing systems by breaking the bond between a software program and its hardware. Although the virtualized computer 202 has a MAC address 214 or other unique identifier, multiple instances of the application 216 running on different virtual machines 218 on the same hardware platform can create difficulties with regard to a vendor requiring a license for each instance of the application. For example, a user can clone the original application 216A. The cloned instances 216B, 216C can include a valid token corresponding to the original application 216A produced during the cloning operation. However, the user can avoid paying a license fee for each copy of the software program 216B, 216C since the user does not need to request a new token for each clone from the licensing server 206. Accordingly, since the cloned instances 216B, 216C are identical to the original application 216A, the licensing server 206 or any internal check procedures will not detect licensing fraud or other unauthorized copying of the original software program 216A.

A software vendor can verify that a license is valid by performing an internal check, for example, using a palindrome or similar string having an internal structure allowing its validity to be determined by comparison, or by requesting a verification from the licensing server 206. Such techniques for detecting license validity can be performed by an optional cloning detection module 222 configured at the storage device 212, the licensing server 206, or a combination thereof. A unique cryptographically derived token can be provided in response to each license request instead of a token derived from the computer's MAC address. It is well known to those of ordinary skill in the art that cryptographically created tokens can be easily verified but are difficult to create. For example, an unencrypted license can include a character string with specific detectable characteristics. One such characteristic can be to configure the unencrypted token as a palindrome such as “abcdcba.” Palindromes or other special strings can be encrypted to produce a license token by the licensing server instead of a MAC address, which can be output to a requesting application 216. This process can include the creation of a cryptographic secret that is unique for each license, which can be easily verified by the software program but cannot be reproduced by the user. Since the user cannot process the cryptographic secret, the user cannot create a cryptographic token that will decrypt a palindrome or a similarly capable string, and therefore cannot create a valid license token for an unauthorized instance of the software program. For additional security, an authentic token can be checked either at the computer 202 or at the licensing server 206.

Another approach is for a vendor to render a license token invalid when detecting a change of a hardware identification footprint. Clones of a software program typically use different hardware identifiers, which can include or be different from a MAC address as described in other examples herein, when standard virtualization management tools are used to clone. However, a user can apply a technique, for example, described herein, to clone a hardware identification footprint in order to activate an unauthorized software program instance. Thus, the abovementioned limitations associated with virtualization technologies with regard to cloning apply here, where valid licensed programs can be configured at different machines as part of failover, load balancing, or related techniques. A token based on a fixed hardware identifier is therefore not feasible. Methods described herein that include the use of palindromes, rolling tokens, and the like can be applied.

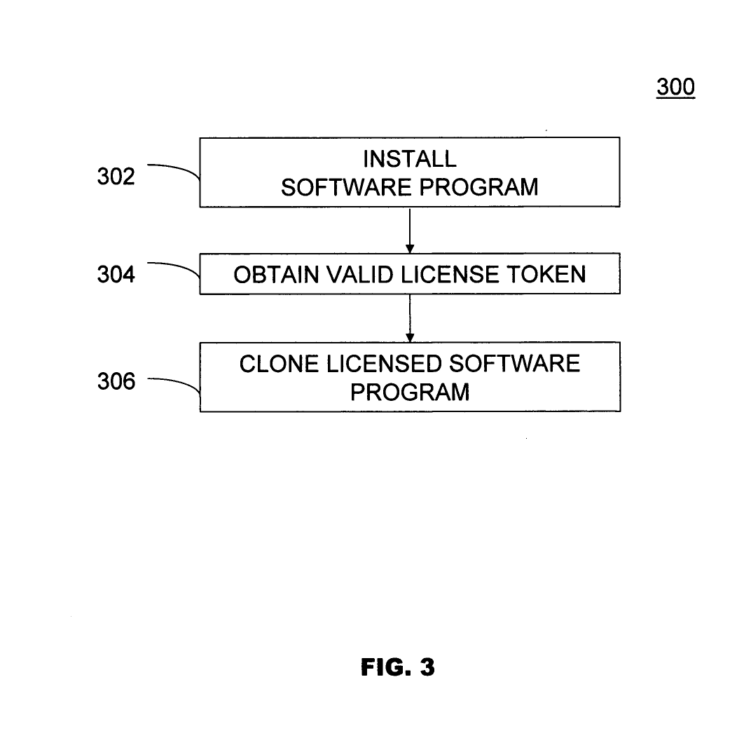

FIG. 3 is a flow diagram of a method 300 for cloning instances of a licensed software program in a virtualization system, in accordance with an embodiment. The method 300 can be governed by instructions that are stored in a memory and can be executed by a processor 208 of the virtualized computer 202 and/or the licensing server 206 of FIG. 2, or a hardware system in communication with the virtualized computer 202, or a combination thereof.

At block 302, a software program 216A is installed in the storage device 212 of the computer 202.

At block 304, a valid license token is obtained from the licensing server 206 for activating the original software program. The license token can be received in a manner that is well-known to those of ordinary skill in the art, for example, encrypted using a cryptographic secret, which can be decrypted by a user with knowledge of the cryptographic secret. Although a license token is described, other forms of software licenses can equally apply such as a key, a file, and the like. The license can be validated by subjecting the license token to an internal consistency check or related validity mechanism.

At block 306, the original software program 216A can be cloned to produce multiple instances 216B, 216C of the original software program 216A. For example, cloning can occur after the original software program 216A is authorized and its license token is decrypted and the software program 216A passes an internal check procedure. Each cloned instance 216B, 216C of the software program can run on a different virtual machine 218, and each instance includes a copy of the software license corresponding to the original software program 216A.

The method 300 thereby prevents the abovementioned types of checks, i.e., an internal check and a request for verification from license server, from detecting a fraudulent or unauthorized clone, since an encrypted license token received by a cloned instance 216B, 216C can be successfully decoded at the cloned instance 216B, 216C and/or the licensing server 206. For example, each cloned instance 216B, 216C can pass a licensing check or a request for verification process since the cloning is performed on the original software program 216A having a valid license token.

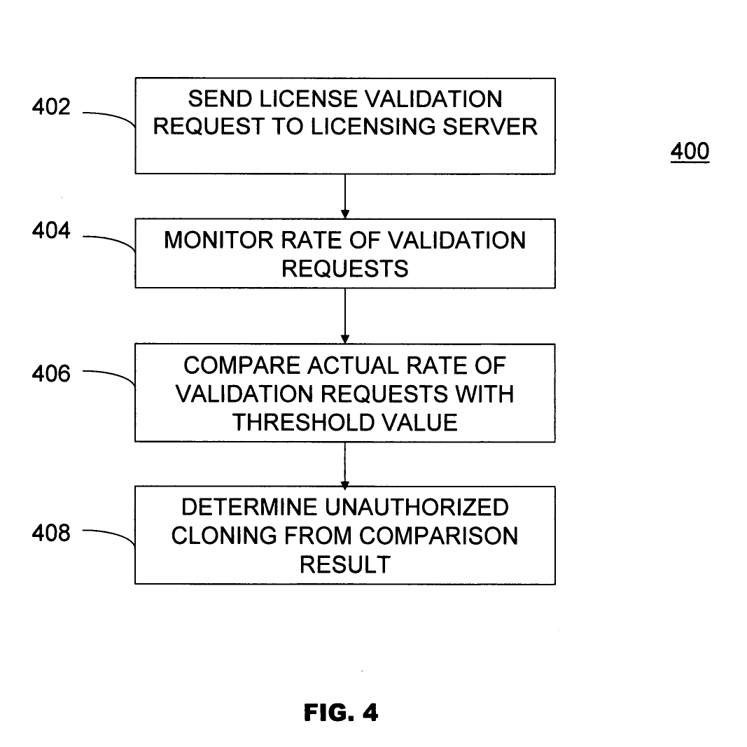

FIG. 4 is a flow diagram of a method 400 for detecting software program cloning fraud, in accordance with an embodiment. The method 400 can be governed by instructions provided at the cloning detection module 222 stored in the memory 212 and can be executed by the processor 208 at the virtualized computer 202 and/or the licensing server 206 of FIG. 2, or a hardware system in communication with the virtualized computer 202, or a combination thereof. The method 400 can be implemented by a vendor, service provider, or related entity attempting to reduce unauthorized copying of software applications or other programs. Accordingly, a vendor and the like can implement each software program 216 configured to generate a license validation request. Each software program instance 216 can be configured to periodically verify its license by requesting validation from the licensing server 206, for example, at predefined times or at random times, depending on the configuration.

At block 402, an instance of the software program 216 generates a license validation request and sends the license validation request to the licensing server 206 to verify whether the license token corresponding to the software program instance 216 is valid, for example, using well-known cryptography techniques. The software program 216 can include the original software program 216A and/or cloned instances 216B, 216C of the software program 216A. The license validation request can include a unique and identifiable license token. For example, the license token can include a customer identification number determined by the vendor that is appended to a serial number identifying a particular instance of the software program 216.

At block 404, the licensing server 206 can be configured to monitor the rate at which the original software program 216A or other instances 216B, 216C of the software program 216A sends a license validation request. The licensing server 206 can be configured with a cloning detection module to determine a rate of license validation requests output from the computer 202.

At block 406, the actual rate of license validation requests generated by the software program 216 is compared to a threshold value. The threshold value can be determined by a software vendor according to a predicted or anticipated rate of license validation requests. For example, a vendor can provide the original software program 216A to a customer that is configured to generate a license validation request at a predetermined rate, which can be used as the threshold value. If other instances 216B, 216C are produced from the original program 216A, and the other instances 216B, 216C likewise generate a license validation request at the same predetermined rate as the original software program 216A, then a comparison can be made by the cloning detection module at the licensing server 106 to the threshold value.

At block 408, a determination can be made as to whether cloning fraud has occurred from the comparison result. In the previous example, the licensing server 206 receives validation requests from each of the software programs 216A, 216B, 216C at a periodic rate that is greater than the threshold value, indicating that multiple application instances are using the same license token. The software vendor can subsequently take remedial actions against the user after determining that unauthorized cloning of the software program 216A occurred, for example, by rejecting the license validation request. Other examples of remedial action can include the generation of an instruction for slowing the program or disabling certain features, logging a detection, and so on. Although the rate of license validation requests is referred to herein, the frequency of license validation requests or other related units of measurement can equally apply.

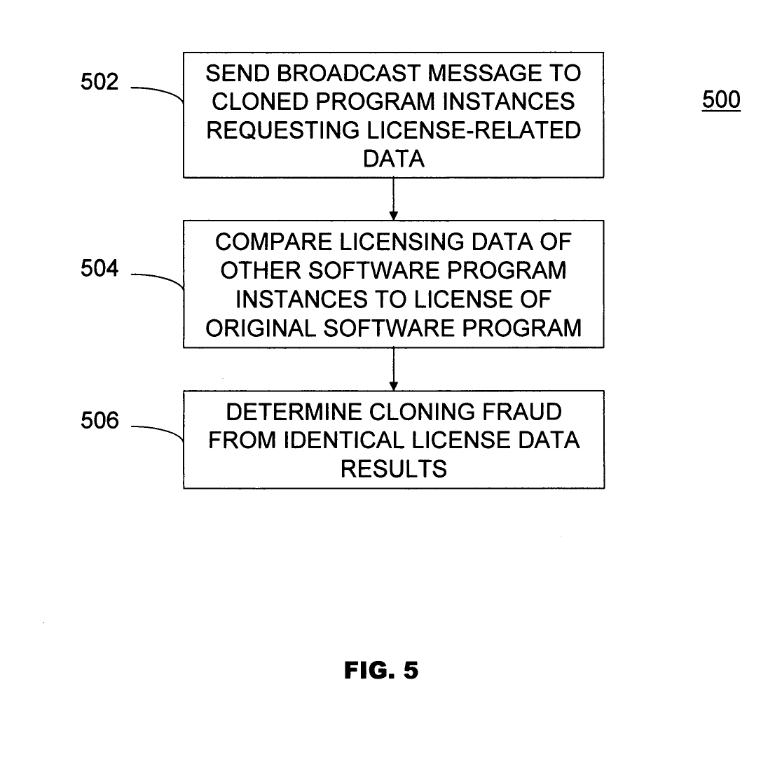

FIG. 5 is a flow diagram of another method 500 for detecting software program cloning fraud, in accordance with an embodiment. The method 500 can be governed by instructions provided at the cloning detection module 222 stored in the memory 212 and can be executed by the processor 208 at the virtualized computer 202 and/or the licensing server 206 of FIG. 2, or a hardware system in communication with the virtualized computer 202, or a combination thereof.

At block 502, the original software program 216A having a valid license can send a broadcast message to cloned instances 216B, 216C, requesting that the cloned instances 216B, 216C present their license tokens, keys, or other license-related data. The cloned instances can present their tokens to the instance 216 which requested them. The instance 216 can then determine if the other program has the same token, which can be interpreted as an indication of an unauthorized instance, for example, indicating possible fraud. The cloned instances 216B, 216C can reside on the same computer 202 as the original software program 216A as shown in FIG. 2, or installed on other computers (not shown) which are connected to the network 14, for example, a same LAN. Alternatively, the broadcast message can be generated from an application programming interface (API) that the virtualized computer 202 uses to communicate with each software program instance 216A-216C.

At block 504, if contact is established between the original software program 216A and the cloned instances 216B, 216C, then the license-related data presented by the cloned instances 216B, 216C is compared with the token or other license-related data of the original software program 216A.

At block 506, a determination can be made that cloning fraud has occurred if a match is established between the license-related data of a cloned instance 216B, 2160 and the license data of the original software program 216A, i.e., the results are identical.

When the method 500 is implemented, a user can reduce the effectiveness of the method 500 by placing the cloned instances 216B, 216C on separate servers or related computer platforms, each server configured for a different LAN. This approach can prevent the original software program 216A from discovering, and establishing contact with, the cloned instances 216B, 216C.

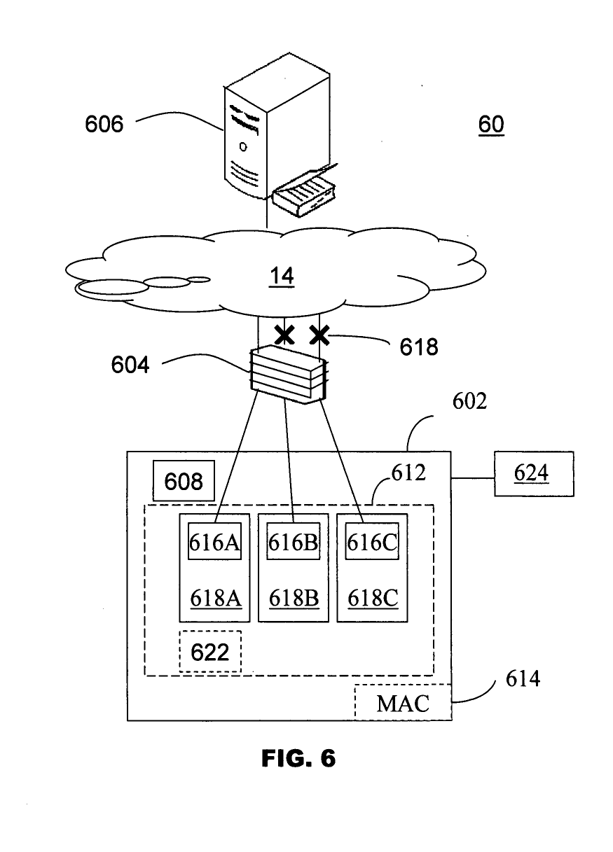

FIG. 6 is a diagram illustrating a network environment 60 in which a licensing server 606 is in communication with a virtualized computer 602, in accordance with an embodiment.

The computer 602 can be configured to host a software application 616A and two cloned instances 616B, 616C (generally, 616) of the software application 616A, which can be stored in a memory 612 and executed by a processor 608. The software application 616A and cloned instances 616B, 616C can be configured in a manner similar to those described in FIG. 2; related details are therefore not repeated for brevity. FIG. 6 also includes a configuration management system 622 that can clone the software application 616A. The configuration management system 624 can also configure the cloned instances 616B, 616C to include their own configuration data. For example, program instances running on a computer can each serve a set of users. Each user may set their preferences for system operation. For example, users on virtualized PBXs may set call forwards, speed dials, or related features. These preferences can be maintained at the configuration management system 624 for failure recovery and the like. Thus, when an application instance 616A is cloned, it contains the preferences for its specific set of users. In some embodiments, for each cloned instance 616B, 616C, these users and preferences are deleted by the configuration management system 624. In other embodiments, configurations related to the users are retained.

As shown in FIG. 6, each software application instance 616 can communicate with the licensing server 606 through a firewall 604. A user of the original software program 616A and its clones 616B, 616C can overcome certain anti-fraud approaches such as those described with regard to FIG. 4 or 5 by configuring the firewall 604 so that outgoing messages from some or all clones 616 are blocked at outputs 618, and therefore prevent the messages from being received by the licensing server 606. To overcome such fraud techniques, the original software program 616A can be configured to perform a validation technique, for example, searching for other instances with identical licensing information as described above.

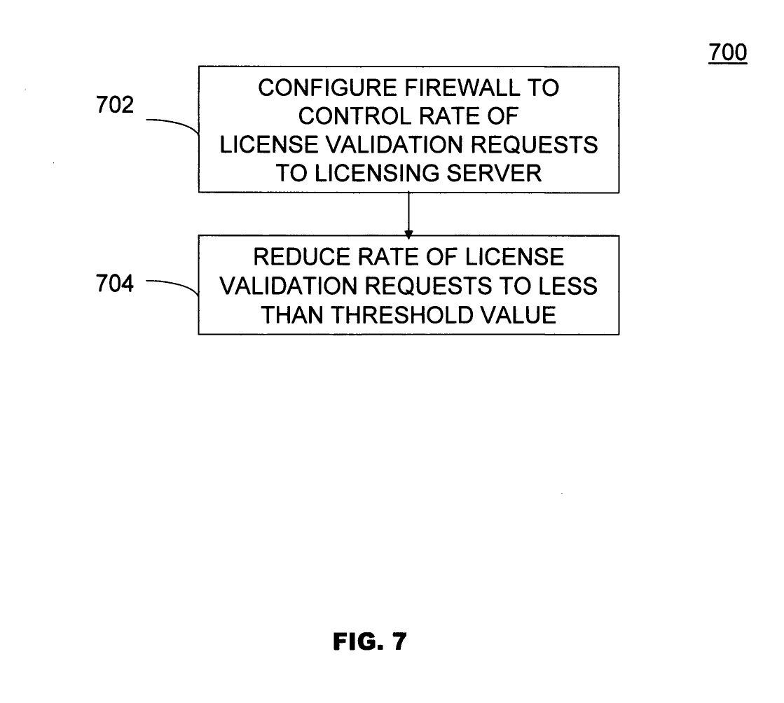

An embodiment in which a related approach for prevent the detection of cloning fraud in a virtualization environment is shown in FIG. 7. In particular, the method 700 shown in FIG. 7 can be implemented in the firewall 604 alone or in combination with the licensing server 606 and/or the computer 602, for example, a cloning detection module 622, to reduce the rate of licensing checks at the licensing server 606, and therefore reduce the effectiveness of detection based on the frequency or rate of license validation requests, for example, describe in FIG. 4. The cloning detection module 622 can be configured at the storage device 612, the licensing server 606, the firewall 604, or a combination thereof.

At block 702, the firewall 604 can be configured to control a rate of license validation requests from the multiple instances 616 to the licensing server 606.

At block 704, the firewall 604 can be configured to reduce the rate of license validation requests to less than a threshold value so that some or all clones 616B, 616C are blocked from sending communications such as license validation requests to the licensing server 606. For example, the firewall 604 can be configured to reduce the rate of license validation requests to less than the threshold value described with reference to FIG. 4. The firewall 604 can be configured to allow license validation requests from specific clones 616 to pass through at only a restricted rate. For example, in the case of two cloned instances 616B, 616C, the firewall 604 can be configured to allow every other license validation request from a specific clone, for example, cloned instance 616B, to pass through, while permitting all requests from another clone, for example, cloned instance 616C to pass through the firewall 604. Similar techniques could be used for any number of clones. The pass-through permitted for particular instances can occur at regular, predetermined intervals or at random times. The rate of licensing checks by the licensing server 606 can be adjusted at the firewall 604 so that the licensing server satisfies a predetermined threshold value that would otherwise trigger a fraud alert.

A vendor or related entity can address the method 700 by configuring the licensed software program 616A to communicate with the licensing server 606. Accordingly, cloned instances 616B, 616C can be required to communicate with the licensing server 606. If a cloned instance 616B, 616C does not communicate with the licensing server 606 as required, a determination can be made that the cloned instance 616B, 616C is invalid and/or is determined to be a fraudulently generated clone.

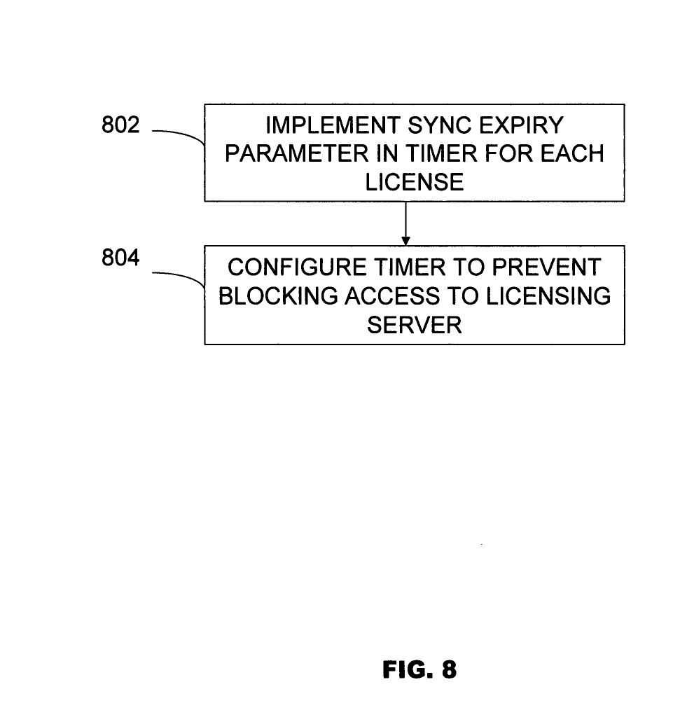

A related approach is described in FIG. 8. In particular, FIG. 8 is a flow diagram of another method for detecting software program cloning fraud, in accordance with an embodiment. The method 800 can be applied by the cloning detection module 622 in response to the firewall 604 being configured to block communications between certain instances of the software program 616 in order to output license validation requests at a rate that is acceptable to the licensing server 606 so that an alarm is not generated, for example, in accordance with the method 700. The method 800 can be governed by instructions that are stored in a memory and can be executed by a processor at the virtualized computer 602, the firewall 604, and/or the licensing server 606 of FIG. 6.

At block 802, a sync expiry parameter is implemented in a timer (not shown) for a license provided to a software program instance 616. The sync expiry parameter includes a predetermined period during which the instance 616 is expected to communicate with the licensing server 604. The sync expiry period can be predefined by the vendor. Accordingly, regardless of whether a license is cloned or otherwise acquired in an unauthorized manner, communication is required between the instance 616 having the license and the licensing server 606. If the timer expires, then the instance 616 can take action such as disabling certain features, sending alerts on GUIs, ceasing operation, and so on.

At block 804, the timer can be configured to prevent the customer from blocking access to the licensing server 606 via the firewall 604. Since each instance 616 will pass internal checks due to the previously described cloning techniques, the licensing server 606 is required to detect the fraud. The timer allows the instance 616 to run, for example, to address timing issues caused by an unreliable Internet. In the event that extended periods of time occur in which a licensing server 606 is unavailable, for example, during a failure. The instance 616 can be configured with a timer that compensates for these failures.

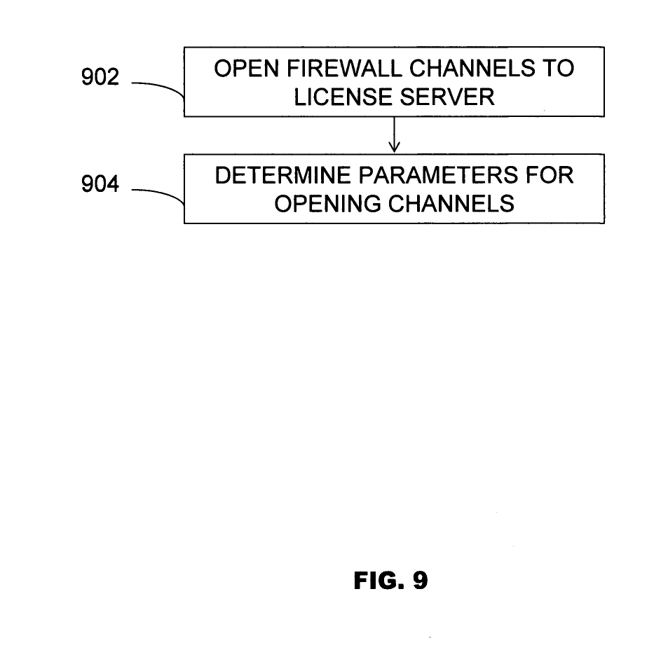

FIG. 9 is a flow diagram of another method 900 for configuring the firewall 604 to prevent the detection of cloning fraud, in accordance with an embodiment. The method 900 can be implemented as an approach to avoiding cloning fraud detection via the method 800 described with respect to FIG. 8. The method 900 can be governed by instructions that are stored in the memory 612 and can be executed by the processor 608 at the virtualized computer 602, the firewall 604, and/or the licensing server 606 of FIG. 6.

At block 902, one or more channels can be opened in the firewall 604 for the cloned instances 616. At block 904, parameters are determined for opening the channels. As described above, the method 800 described herein provides an approach for detecting cloning fraud by establishing a period of time, referred to as a sync expiry period, during which the licensing server 606 expects to receive a communication such as a license validation request from a software program instance 616. On the other hand, the previously described method 400 provides another approach for detecting cloning fraud by detecting an excessive rate of license validation requests from multiple clones of a software program. Accordingly, the configuration manager 624 can be configured to open one or more channels for a period sufficient to permit a cloned instance 616 to output a communication via the firewall 604 to the licensing server 606 during a prefined sync expiry period. However, the configuration manager 624 can also be configured to open the channels sufficient to reduce a rate of license validation requests output from the cloned instances 616 to less than the threshold value described with reference to the method 400 of FIG. 4.

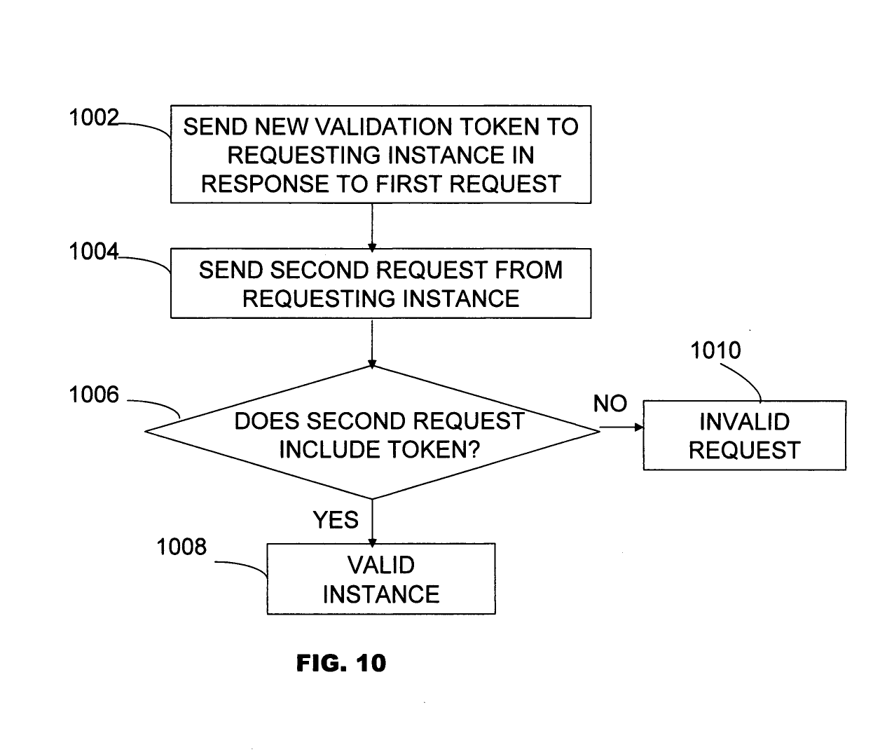

FIG. 10 is a flow diagram of a method 1000 for detecting a license request from a software program clone, in accordance with an embodiment. The method 1000 can be applied either in response to or independent of the implementation of the method 900 described herein. The method 1000 can be governed by instructions of the cloning detection module 622 stored in the memory 612 and can be executed by the processor 608 at the virtualized computer 602, the firewall 604, and/or the licensing server 606 of FIG. 6.

At block 1002, a new validation token is generated and output for each license validation request, i.e., a first validation request, received by the licensing server 606. The licensing server 606 can be configured to expect that the validation token is returned when a subsequent license validation request, i.e., a second validation request, is made by a software instance 616.

At block 1004, the second license validation request is sent from the software instance 616 to the licensing server 606. The validation token can be returned to the licensing server 606 with the second license validation request.

At decision block 1006, a determination is made whether the second license validation request includes the validation token. If the validation token is returned to the licensing server 606, then at block 1008, the instance 616 is validated as an authorized instance 616. Otherwise, at block 1010, if the licensing server 606 does not receive a license validation request with the returned validation token by the instance 616, then the second license validation request can be deemed invalid, and the instance 616 can be identified as being an unauthorized instance 616

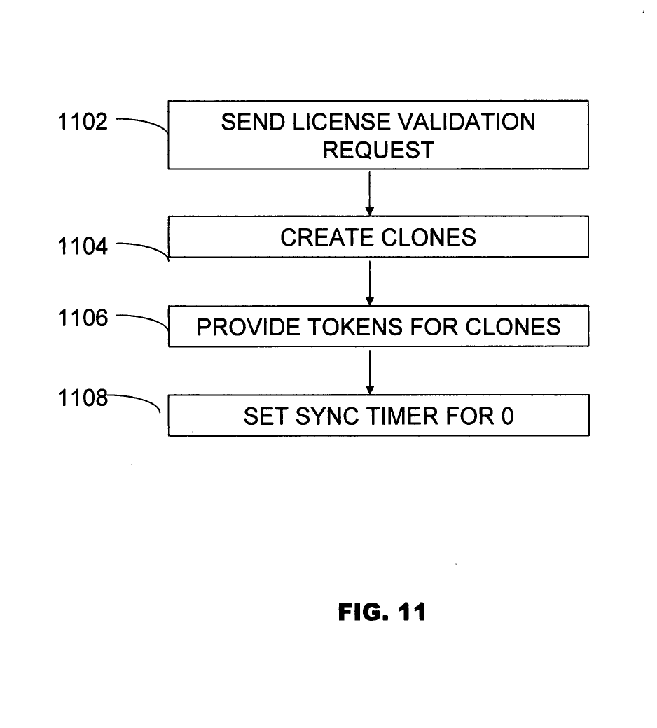

FIG. 11 is a flow diagram of a method 1100 for performing repetitive cloning, in accordance with an embodiment. The method 1100 can be applied in response to the method 1000 of FIG. 10.

At block 1102, a license validation request is sent from a valid software program.

At block 1104, one or more cloned instances 616B, 616C are created of the valid software program after the license validation request is generated. The configuration management system 624 can be used to clone the valid software program. At block 1106, each cloned instance 616B, 616C is configured to include a new token. New tokens can be provided by the licensing server 606 in accordance with methods described herein. Each cloned instance can have a timer as described in the method 900 of FIG. 9. At block 1108, each timer is configured to have a synchronization time of 0. Accordingly, the configuration management system 624 can update the clones with a unique configuration, for example, a configuration having specific user preferences and the like.

The licensing server 606 will be unaware of the cloned instances 616B, 616C and therefore cannot detect them. Internal techniques can be applied to a running instance 616 to determine if it has a valid token. The licensing token can be set so that it is valid for only a certain period of time. Thus if an instance is prevented from communicating with the licensing server for a period of time to reset this licensing timer, the application instance can use this as an indication of licensing fraud. This technique can detect the restriction of requests by the firewall 604 in certain circumstances but is not able to detect the repetitive cloning fraud technique. The repetitive cloning technique can be detected by foregoing techniques in which an instance 616 will attempt to find other running instances and compare licensing tokens for identification.

Another method of overcoming the repetitive cloning fraud is to increase the frequency of licensing requests so that the repetitive cloning technique will cause unacceptable loss of service to the customer. However this technique has difficulty when confronted with the unreliability of the connectivity to the licensing server provided by the Internet. The Internet is an uncertain system and there will be periods of time in which connectivity with certain portions of it are disabled. A possible technique to overcome the firewall fraud would be to initiate, fraud mitigation methods if connection to the licensing server is lost. However because of the unreliability of the Internet, this is not practical for many installations. Therefore software program instances 616 can be set to tolerate certain periods of being unable to communicate with a licensing server 606 before taking the lack of ability to communicate as an indication of licensing fraud. This opens a window for unscrupulous customers with certain types of applications to use the repetitive cloning fraud technique. The technique described above in which software program instances 616 will search for other instances can be used in this case.

As well, there will be certain installations for which there is either no access to the Internet or access is undesirable for security reasons. In such circumstances, abovementioned methods can relate to a manual process, for example, where the updated license is received by telephone or other form of communication. In such circumstances, the detection of fraud by the licensing server 606 is not possible and the customer could create any number of clones using techniques described above. In such a case, the method described above of the instances searching for other instances over a network such as a LAN can be created.

Once a potential fraudulent situations detected by the techniques described above or by similar means, then mitigation technique may be set up. These techniques can be initiated either by the licensing server 606 or by the application instance 616. Such techniques can vary from providing information to a customer and the need to renew a license, to allowing the application by delaying execution of service requests, providing popup warnings, etc., and finally, to the complete disablement of the application. Extreme techniques can include the prevention of a user, for example, a customer, to access data by encryption or other techniques.

While the invention has been shown and described with reference to specific embodiments, it should be understood by those skilled in the art that various changes in form and detail may be made therein without departing from the spirit and scope of the invention as recited in the accompanying claims.

It should be also understood that many of the functional units described in this specification have been labeled as modules or systems, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

A storage device can include a computer readable storage medium, which may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

What is claimed is:

1. A computer-implemented method for activating an unauthorized software program in a virtualization environment, comprising:
installing a software program on a computer;
obtaining a valid license to activate the software program;
performing a cloning operation on the software program;
generating at least one other instance of the software program during the cloning operation; and
obtaining the valid license to activate the at least one other instance of the software program.

2. The method of claim 1, further comprising:
performing a validation operation on the at least one other instance; and
authorizing an activation of the at least one other instance with the copy of the valid license in response to performing the validation operation.

3. The method of claim 1, wherein the valid license includes a license token.

4. The method of claim 1, further comprising:
positioning the at least one other instance of the software program on a different physical machine than the computer.

5. The method of claim 4, wherein the computer and the different physical machine are connected to different local area networks.

6. The method of claim 1, wherein the computer includes a plurality of virtual machines and the at least one other instance is at the virtual machine.

7. The method of claim 1, further comprising:
providing a firewall to facilitate a communication between the computer and a licensing server;
controlling at the firewall a rate of license validation requests from the at least one instance to the licensing server; and
reducing the rate of license validation requests to less than a threshold value.

8. The method of claim 7, wherein the threshold value is determined according to an anticipated rate of license validation requests.

9. The method of claim 1, further comprising:
controlling at the firewall one or more channels to output communications received from the computer to a licensing server; and
opening a channel of the one or more channels for a period of time to output a communication expected to be received by the licensing server during the period of time and to reduce a rate of communications from the computer to the licensing server to less than a threshold value.

10. The method of claim 1, wherein the valid license includes a cryptographically unique license token comprising a palindrome or other character string.

11. The method of claim 10, wherein the license is validated by subjecting the license token to an internal consistency check.

12. The method of claim 1, further comprising:
outputting a license validation request from the activated software program;
creating the at least one other instance of the software program after outputting the license validation request;
receiving by the at least one other instance of the software program a new token;
configuring the at least one other instance of the software program to have a sync time of 0; and
modifying the at least one other instance of the software program having the new token with a specific configuration.

13. A computer-implemented method for detecting software program cloning fraud, comprising:
outputting at least one license validation request from a cloned software program to a licensing server, the cloned software program having a license;
monitoring a rate of license validation requests;
comparing the rate of license validation requests with a threshold rate value; and
determining that the cloned software program is unauthorized in response to the comparison establishing that the rate of license validation requests exceeds the threshold rate value.

14. The method of claim 13, wherein outputting at least one license validation request comprises outputting a license token to the licensing server and wherein determining that the cloned software is unauthorized comprises determining that the license token is invalid.

15. The method of claim 13, further comprising:
implementing a sync expiry parameter for the license of the cloned software program, the sync expiry parameter including a predefined sync expiry period during which the licensing server expects to receive a communication from the cloned software program; and
preventing access to the licensing server from being blocked at a firewall.

16. The method of claim 12, further comprising:
receiving by the licensing server one or more first license validation requests from one or more cloned software programs;
generating a validation token in response to a received license validation request;
authorizing a first cloned program in response to receipt by the licensing server a second license validation request that includes data related to the validation token; and
identifying a second cloned program as an unauthorized cloned instance in response to receipt by the licensing server a third license validation request that is devoid of data related to the validation token.

17. The method of claim 16, wherein a validation token is provided by the licensing server in response to each first license validation request.

18. The method of claim 16, further comprising outputting by the second cloned program an older token with the third license validation request.

19. A system for detecting software program cloning fraud, comprising:
a computer server having at least one instance of a licensed virtualized application; and
a cloning detection module that monitors a rate of license validation requests output from the computer server, the cloning detection module having a comparator that compares the rate of license validation requests with a threshold rate value, the cloning detection module determining that the cloned software program is unauthorized in response to the comparison establishing that the rate of license validation requests exceeds the threshold rate value.

20. The system of claim 19, further comprising a firewall that controls a rate of license validation requests from the at least one instance to the licensing server; and
reducing the rate of license validation requests to less than a threshold value.
